(19) United States
(12) Patent Application Publication
(10) Pub. No.: US 2010/0059993 A1
(43) Pub. Date: Mar. 11, 2010

(54) CAPILLARY COLUMN CONNECTOR

(75) Inventor: Koji Omiya, Otsu-shi (JP)

Correspondence Address: DARBY & DARBY P.C., P.O. BOX 770, Church Street Station, New York, NY, 10008-0770, US

(73) Assignee: Shimadzu Corporation, Kyoto-Shi (JP)

(21) Appl. No.: 12/490,548

(22) Filed: Jun. 24, 2009

(30) Foreign Application Priority Data
Sep. 9, 2008 (JP) 2008-230890

(51) Int. Cl. F16L 35/00

(52) U.S. Cl. 285/332

(57) ABSTRACT

A capillary column connector comprising a metal connector main body having a first column installation port into which a first capillary column is inserted, a second column installation port into which a second capillary column is inserted, an internal space, in which are arranged the tip of the first capillary column inserted from said first capillary installation port and the tip of the second capillary column inserted from said second capillary installation port, and a gas supply route that is connected to the interior space, wherein a tubular member is provided which can move in and out of the aforementioned internal space, and the tubular member, in which the tip of the first capillary column is inserted from one end and the tip of the second capillary column is inserted from the other end, is arranged in the internal space.

The present invention claims priority under 35 U.S.C. §119 to Japanese Patent Application No. 2008-230890 filed on Sep. 9, 2008. The content of the application is incorporated herein by reference in its entirety.

### TECHNICAL FIELD

The present invention relates to a capillary column connector.

### BACKGROUND OF THE INVENTION

Gas chromatographs (separation devices) have been disclosed that can separate just the low boiling point hydrocarbons from sample gas in which low boiling point hydrocarbons (for example, CH₄, C₂H₂, C₃H₈ and the like) targeted for measurement and high boiling point hydrocarbons (for example, benzene, toluene, xylene and the like) have been mixed (for example, Japan Unexamined Patent Publication No. H6-148166).

Here, an example of a gas chromatograph that can separate just the low boiling point hydrocarbons will be explained. FIG. 3 and FIG. 4 are schematic configurational diagrams of one example of a gas chromatograph.

This kind of gas chromatograph 1 is composed of: a injection port 2 into which sample gas is introduced; a detector 3; a pressure regulator 4; a first capillary column 5 connected with the injection port 2; a second capillary column 6 connected with the detector 3; a gas supply flow path 7 connected with the pressure regulator 4; a capillary column connector C, which couples in the internal space the first capillary column 5, the second capillary column 6, and the gas supply flow path 7; and a control unit (not indicated in the diagram) that controls the pressure regulator 4, etc. in order to switch the flow path.

The first capillary column 5 is a cylindrical tube, and the internal diameter is commonly 0.1 mm to 0.5 mm while the external diameter is commonly 0.5 to 0.8 mm. Then, a stationary phase is packed inside of the first capillary column 5, and the high boiling point hydrocarbons are absorbed when the sample gas passes through the first capillary column 5.

The second capillary column 6 is a cylindrical tube, and the internal diameter is commonly 0.1 mm to 0.5 mm while the external diameter is commonly 0.5 to 0.8 mm. A stationary phase is not packed into the interior of the second capillary column 6.

As first indicated in FIG. 3, in this kind of gas chromatograph 1, while the controller controls the pressure regulator 4 such that the pressure within the injection port 2 is higher than that in the capillary column connector C, the sample gas that is introduced into the injection port 2 moves from the first capillary column 5 to the second capillary column 6 by introducing carrier gas for purging from the gas supply flow path 7 into the internal space of the capillary column connector C.

Then, as indicated in FIG. 4, at the stage of just the low boiling point hydrocarbons in the sample gas having passed through the first capillary column 5, while the controller controls the pressure regulator 4 such that the pressure in the injection port 2 is lower than that of the capillary column connector C, the high boiling point hydrocarbons adsorbed to the first capillary column 5 are back-flushed by introducing carrier gas from the gas supply flow path 7 into the interior space of the capillary column connector C, and the high boiling point hydrocarbons are discharged from the injection port 2 connected to the inlet end of the first capillary column 5, and the low boiling point hydrocarbons are introduced into the detector 3 connected to the outlet end of the second capillary column 6.

By back-flushing, the low boiling point hydrocarbons that pass through the second capillary column 6 are continuously measured while the first capillary column 5 is cleaned.

The following is a description of a glass press-tight connector, which is one example of a capillary column connector that connects the first capillary column 5 and the second capillary column 6.

The glass press-tight connector is formed in a Y-shape having a first column installation port into which the first capillary column 5 is inserted, a second column installation port into which the second capillary column 6 is inserted, a cylindrically shaped internal space in which the tip of the first capillary column 5 and the tip of the second capillary column 6 are arranged, and the gas supply flow route 7, which is connected to the internal space.

The first column installation port becomes gradually narrower facing from the tip to the internal space. Moreover, the second column installation port also becomes gradually narrower facing from the tip to the internal space.

In this kind of press-tight connector, by pressing the first capillary column 5 into the first column installation port and compressing the first capillary column 5 against the internal wall, it is possible to connect the first capillary column 5 so that no sample gas leaks. Moreover, in the same way, by pressing the second capillary column 6 into the second column installation port, it is possible to connect the second capillary column 6 so that no sample gas leaks.

Further, when the low boiling point hydrocarbons in the sample gas move from the first capillary column 5 to the second capillary column 6, they come in contact with the internal peripheral surface of the press-tight connector at the internal space, but hardly any is adsorbed to the internal peripheral surface because the press-tight connector is made of glass.

Nonetheless, with the press-tight connector, in addition to difficulties connecting the capillary columns 5 and 6 so that there are no sample gas leaks, there is the problem that the press-tight connector may be damaged because they are made of glass.

Further, once the capillary columns 5 and 6 are removed from the press-tight connector, the press-tight connector must be replaced with a new part because press-tight connectors cannot be reused, and thus there is the problem of extremely high costs.

Thus, metal unions made of metal (for example, SUS, iron, brass and the like) that can be reused even if the capillary columns 5 and 6 are temporarily removed have been developed.

Metal unions will be explained here. FIG. 5 is a cross-sectional diagram of one example of a metal union. A metal union C2 is composed of a metal connector main body 40, two ferrules 31, and two metal nuts 42.

The connector main body 40 is made in a T-shape having a first column installation port 40a in which the first capillary column 5 is inserted, a second column installation port 40b in which the second capillary column 6 is inserted, a cylindrically shaped internal space 40c in which the tip of the first capillary column 5 and the tip of the second capillary column 6 are arranged in close proximity, and a gas supply flow path 7 connected to the internal space 40c.

A ferrule mating space that gradually narrows facing from the tip to the internal space 40c is formed in the first column installation port 40a, and a screw part 40d is formed on the exterior surface of the tip of the connector main body 40 on which the first column installation port 40a is formed.

A ferrule mating space that gradually narrows facing from the tip to the internal space 40c is also formed in the second column installation port 40b, and a screw part 40e is formed on the exterior surface of the tip of the connector main body 40 on which the second column installation port 40b is formed.

The gas supply flow path 7 is connected to the middle of the side surface of the internal space 40c by welding to the connector main body 40.

The ferrule 31 is conically shaped having in the center a hole through which the capillary columns 5 and 6 are tightly fit and mounted, and is formed of compressible resin or metal (for example, flexible graphite, polyimide, graphite/polyimide and the like).

The nuts 42 are cylindrical having a stage difference structure in which the internal diameter abruptly becomes smaller, and by screwing onto the screw parts 40d and 40e on the outer peripheral surface of the connector main body 40, the ferrules 31, which are arranged in the ferrule mating spaces, can be secured to the connector main body 40 while being compressed by the stage difference structure.

With this kind of metal union C2, after the first capillary column 5, on the periphery of which the ferrule 31 is mounted, has been inserted into the first column installation port 40a, the first capillary column 5 can be connected to the connector main body such that there is no leakage of the sample gas by screwing the nut 42 onto the screw part 40d of the peripheral surface of the end of the connector main body 40 thereby compressing the ferrule 31.

Moreover, in the same way, after the second capillary column 6, on the periphery of which the ferrule 31 is mounted, has been inserted into the second column installation port 40b, the second capillary column 6 can be connected to the connector main body such that there is no leakage of the sample gas by screwing the nut 42 onto the screw part 40e of the peripheral surface of the end of the connector main body 40 thereby compressing the ferrule 31.

However, it is difficult to make the interior space 40c of the metal union 40 have a volume of 15 μL or less, which is at the limit from the perspective of processing technology, and the affects of 15-μL dead volume connecting the first capillary column 5 and the second capillary column 6 on the gas chromatograph 1 are extremely large since the peak height detected by the detector 3 drops about ½ to ⅔, and peak shape tailing and deterioration of the sensitivity and quantitative performance occur.

Consequently, the affects of dead volume are decreased by introducing carrier gas for purging from the gas supply flow path 7 into the interior space 40c.

In this regard, when moving from the first capillary column 5 to the second capillary column 6, the low boiling point hydrocarbons in the sample gas come into contact with the inner peripheral surface of the metal union C2 in the internal space 40c, and it is necessary to conduct deactivation treatment on the inner peripheral surface of the metal union C2 in order that nearly no adsorption to the inner peripheral surface occurs.

Nonetheless, it is extremely costly to conduct deactivation treatment of the inner peripheral surface of the metal union C2 because special processing is required.

Further, it is possible to reuse the metal union C2 even once the capillary columns 5 and 6 have been removed from the metal union C2, but if the inner peripheral surface of the metal union C2 has become contaminated by high boiling point hydrocarbons and the like, then the metal union C2 must be replaced with a new part because the metal union C2 cannot then be reused, and the extremely high cost is a problem.

Thus, in view of reducing the costs, an object of the present invention is to provide a capillary column connector that can reduce the affects of dead volume.

### SUMMARY OF THE INVENTION

The capillary column connector of the present invention for resolving the aforementioned problems is a capillary column connector including a metal connector main body having a first column installation port into which a first capillary column is inserted, a second column installation port into which a second capillary column is inserted, an internal space, in which are arranged the tip of the first capillary column that has been inserted from the aforementioned first capillary installation port and the tip of the second capillary column that has been inserted from the aforementioned second capillary installation port, and a gas supply route that is connected to the aforementioned interior space, wherein a metal tubular member is provided which can be moved in and out of the aforementioned internal space, and with the tip of the first capillary column inserted from one end of the aforementioned tubular member and the tip of the second capillary column inserted from the other end of the aforementioned tubular member, the tubular member is arranged in the aforementioned internal space, and the gap between the internal peripheral surface of one end of the aforementioned tubular member and the outer peripheral surface of the first capillary column as well as the gap between the internal peripheral surface of the other end of the aforementioned tubular member and the outer peripheral surface of the second capillary column are purged with gas from the aforementioned gas supply flow path.

According to the capillary column connector of the present invention, a metal tubular member is provided that can be moved in and out of the aforementioned internal space. Then, the tubular member is arranged in the interior space with the tip of the first capillary column inserted from one end and the tip of the second capillary column inserted from the other end.

The affects of the dead volume on the interior space can thus be reduced by transferring sample gas from the first capillary column to the second capillary column while purging with gas from the gas supply flow path the space between the inner peripheral surface of the one end of the tubular member and the outer peripheral surface of the first capillary column, and the space between the inner peripheral surface of the other end of the tubular member and the outer peripheral surface of the second capillary column.

Further, there is no contamination of the inner peripheral surface of the connector main body by sample gas, and if, for example, the inner peripheral surface of the tubular member becomes contaminated, only the tubular member needs to be replaced with a new part.

As described above, according to the capillary column connector of the present invention, costs can be reduced because it is not necessary to conduct deactivation treatment of the interior surface of the connector main body, and the inner peripheral surface of the connector main body does not become contaminated and does not need to be replaced with a new part.

Further, by using a tubular member, the affects of dead volume can be reduced.

Moreover, in the above invention, the aforementioned inner peripheral surface of the tubular member may be inert in relation to the sample gas that flows in the aforementioned first capillary column and second capillary column.

According to the capillary column connector of the present invention, it is not necessary to conduct deactivation treatment in the inner peripheral surface of the connector main body, and it is possible to avoid the low boiling point hydrocarbons in the sample gas adsorbing to the inner peripheral surface.

In addition, in the above invention, ferrule mating spaces are formed in the aforementioned first column installation port and second column installation port, and compressible ferrules that fulfill the role of a seals may be mounted on the external peripheral surfaces of the aforementioned first capillary column and second capillary column, and may then be inserted into the aforementioned first column installation port and second column installation port.

In addition, in the above invention, a lid member is provided in which is formed a mating space for the ferrule of the aforementioned second column installation port. The aforementioned lid member is installed on the aforementioned connector main body, and can be removed from the aforementioned connector main body. The aforementioned tubular member can be moved in and out of the aforementioned internal space by removing the aforementioned lid member from the connector main body, and the tubular member may be secured in the aforementioned internal space by assembling the aforementioned lid member on the connector main body.

### BRIEF DESCRIPTION OF THE DRAWINGS

FIG. 1 is an assembly cross-sectional diagram of one example of a metal union related to an embodiment;

FIG. 2 is a disassembly cross-sectional diagram of the metal union indicated in FIG. 1;

FIG. 3 is a schematic configurational diagram of one example of a gas chromatograph;

FIG. 4 is a schematic configurational diagram of one example of a gas chromatograph; and

FIG. 5 is a cross-sectional diagram of one example of a metal union.

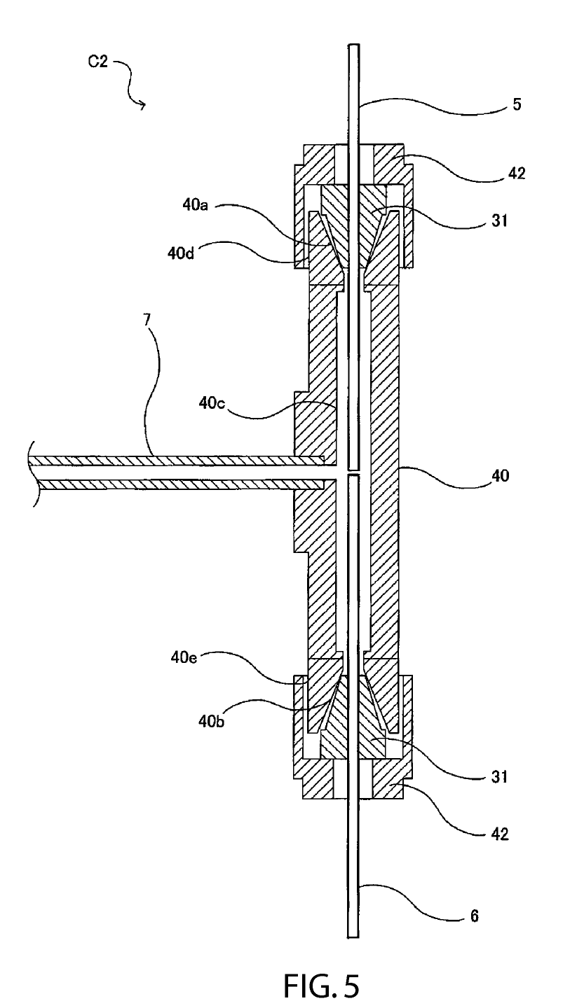

### DETAILED DESCRIPTION OF THE INVENTION

Embodiments of the present invention will be explained below using diagrams. However, the present invention is not limited to the embodiments used in the explanation, and may naturally include various forms within the range that does not violate the intention of the present invention.

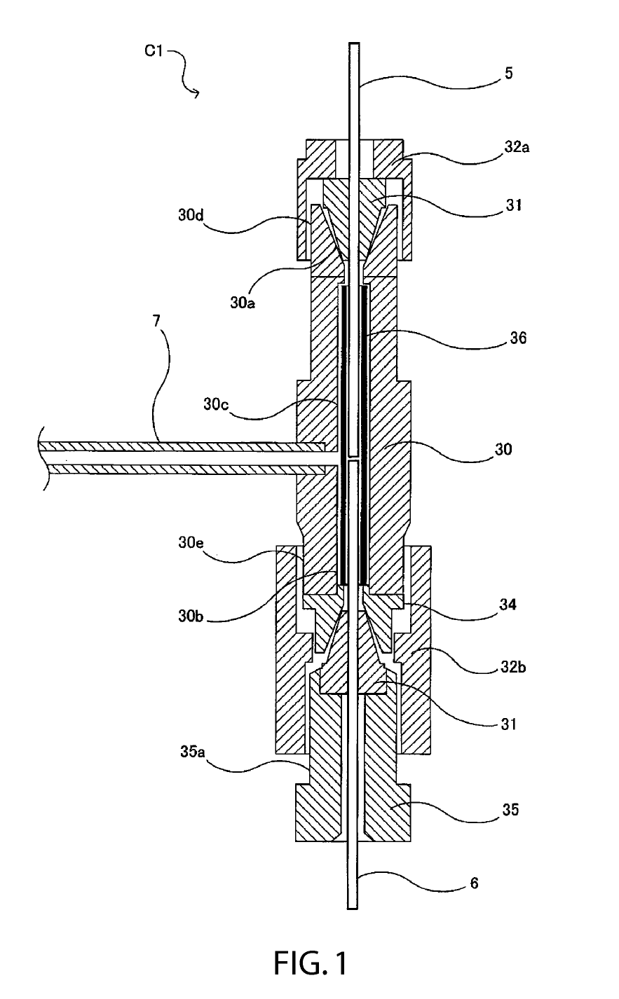

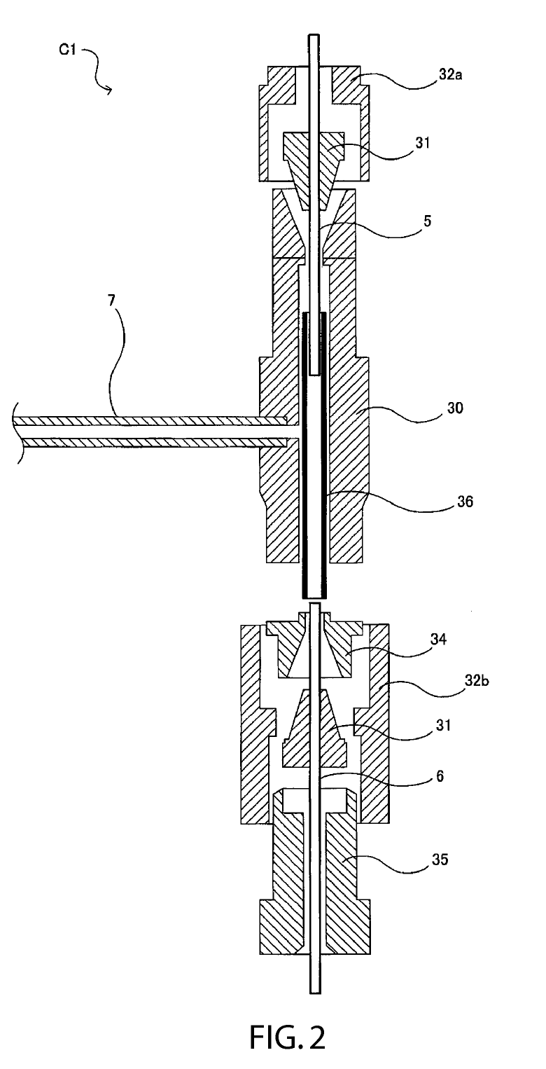

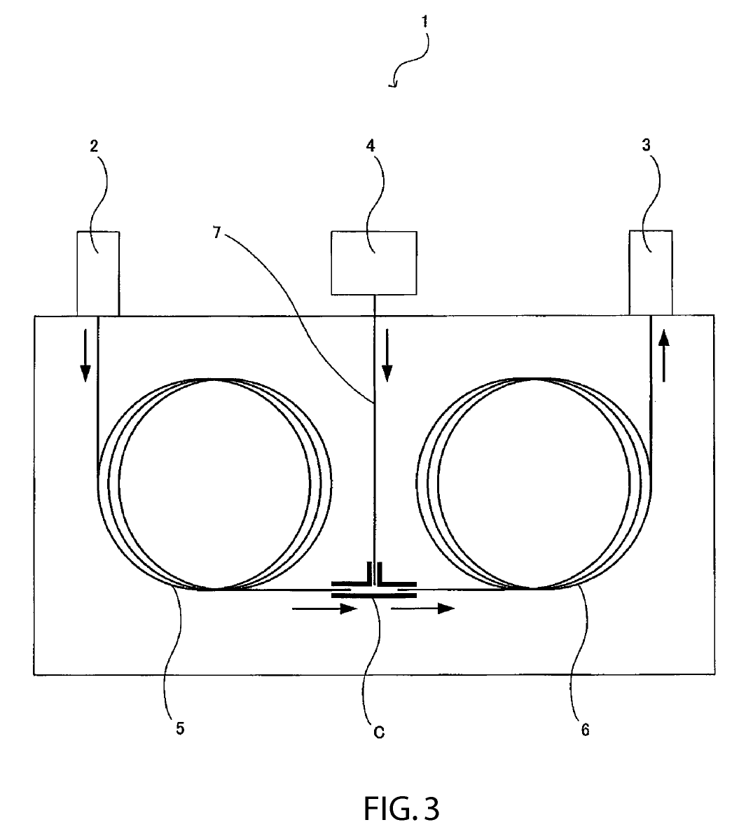

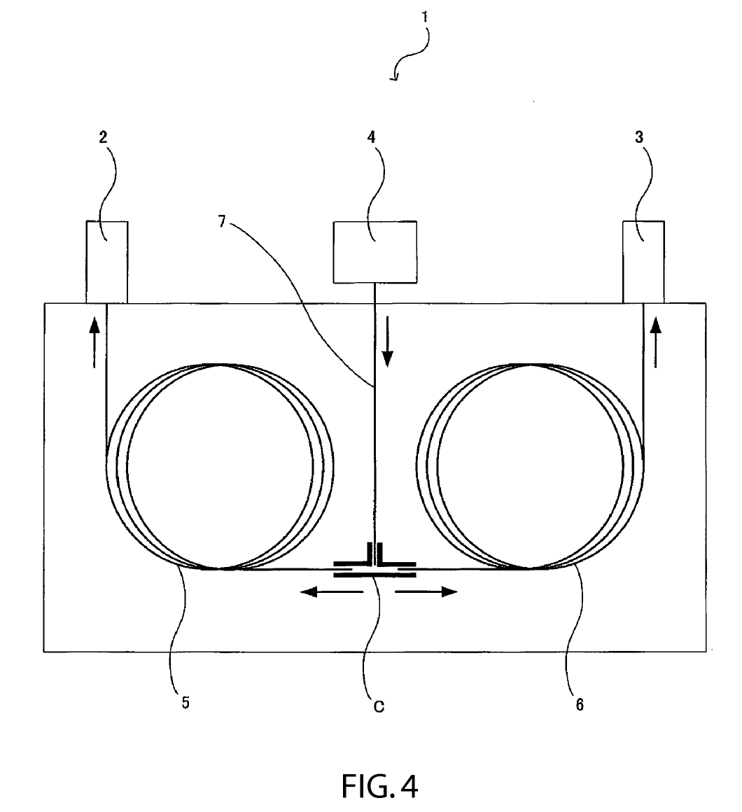

FIG. 3 and FIG. 4 are schematic configuration diagrams of one example of a gas chromatograph that can separate just the low boiling point hydrocarbons of a sample gas in which low boiling point and high boiling point hydrocarbons are mixed. Moreover, FIG. 1 is an assembly cross-structural diagram of one example of a metal union (capillary column connector) related to the embodiment; and FIG. 2 is a disassembly cross-sectional diagram of the metal union indicated in FIG. 1. Further, the metal union C1 is the same in both and is given the same codes.

The gas chromatograph 1 is composed of: a injection port 2 into which sample gas is introduced; a detector 3; a pressure regulator 4; a first capillary column 5 connected with the injection port 2; a second capillary column 6 connected with the detector 3; a gas supply flow path 7 connected with the pressure regulator 4; a capillary column connector C, which couples in the internal space the first capillary column 5, the second capillary column 6, and the gas supply flow path 7; and a control unit (not indicated in the diagram) that controls the pressure regulator 4, etc. in order to switch the flow path.

A metal union C1 is composed of a metal connector main body 30, two ferrules 31, a metal nut 32a, a metal nut 32b, a metal lid member 34, a metal pressing member 35, and a metal tube (tubular member) 36.

The connector main body 30 is made in a T-shape having a first column installation port 30a in which the first capillary column 5 is inserted, a second column installation port 30b in which the second capillary column 6 is inserted, a cylindrically shaped internal space 30c in which the tip of the first capillary column 5 and the tip of the second capillary column 6 are arranged in close proximity, and a gas supply flow path 7 connected to the internal space 30c.

A ferrule mating space that gradually narrows facing from the tip to the internal space 30c is formed in the first column installation port 30a, and a screw part 30d is formed on the exterior peripheral surface of the tip of the connector main body 30 on which the first column installation port 30a is formed.

The interior diameter of the second column installation port 30b is formed to be larger than the exterior diameter of tube 36; the tube 36 can move in and out of the interior space 30c through the second column installation port 30b; and a screw part 30e is formed on the outer peripheral surface of the end of the connector main body 30 on which the second column installation port 30b is formed.

The gas supply flow path 7 is joined to the center of the side surface of the interior space 30c by being welded to the connector main body 30.

The lid member 34 is cylindrically shaped with a hole in the center, and has a ferrule mating space that gradually narrows facing from one end to the other. In addition, a groove (not indicated in the diagram) is formed in the other end surface of the lid member 34; the groove forms a gap in the contact surface between the other end surface of the lid member 34 and the tube 36; and carrier gas is introduced into the tube 36 from the end of the tube 36 through the gap.

The nut 32a is cylindrically shaped having a stage difference structure in which the internal diameter abruptly becomes smaller, and by screwing the screw part 30d on the outer peripheral surface of the connector main body 30, the ferrule 31, which is arranged in the ferrule mating space, can be secured to the connector main body 30 while being compressed by the stage difference structure.

The nut 32b is a long narrow cylindrical shaped having a protruding structure in which the internal diameter abruptly becomes smaller, and by screwing the screw part 30e on the outer peripheral surface of the connector main body 30, the lid member 34, which is arranged in second column installation port 30b, can be secured to the connector main body 30 through a packing (not indicated in the diagram) while being pressed by the protruding structure.

The pressing member 35 is cylindrically shaped with a hole in the center, has a screw part 35a formed on the outer peripheral surface, and can be secured to the connector main body 30 by screwing into the inner peripheral surface of the nut 32b while compressing the ferrule 31 arranged in the ferrule mating space of the lid member 34.

The tube 36 is cylindrically shaped, and is arranged in the interior space 30c such that the tip of the first capillary column 5 is inserted in the center from one end and the tip of the second capillary column 6 is inserted into the center from the other end. At this time, a gap is formed between the inner peripheral surface of the tube 36 and the outer peripheral surfaces of the capillary columns 5 and 6. Because the gap between the inner peripheral surface of one end of the tube 36 and the outer peripheral surface of the first capillary column 5 and the gap between the inner peripheral surface of the other end of the tube 36 and the outer peripheral surface of the second capillary column 6 are purged by introducing carrier gas for purging from the gas supply flow path 7 into the interior space 30c, when the low boiling point hydrocarbons in the sample gas move from the first capillary column 5 to the second capillary column 6, there is only contact with the inner peripheral surface of the tube 36 and no contact with the inner peripheral surface of the connector main body 30 in the interior space 30c. Further, the inner peripheral surface of the tube 36 is inert in relation to the sample gas.

Here, an example of the method of assembling the metal union C1 will be described (refer to FIG. 1 and FIG. 2). First, the tube 36 is arranged in the interior space 30c through the second column installation port 30b.

Next, by inserting the lid member 34 into the second installation port 30b and screwing the nut 32b onto the screw part 30e of the outer peripheral surface of the end of the connector main body 30, the nut 32b is secured to the connector main body 30 while pressing the lid member 34 with the protruding structure.

Then, after inserting the first capillary column 5 with the ferrule 31 mounted on the outer periphery into the first column installation port 30a, the first capillary column 5 and the connector main body 30 are connected such that the sample gas does not leak by screwing the nut 32a onto the screw part 30d of the outer peripheral surface of the end of the connector main body 30 and compressing the ferrule 31. At this time, the tip of the first capillary column 5, which is arranged in the interior space 30c is inserted into one end of the tube 36.

Next, after inserting the second capillary column 6 with the ferrule 31 mounted on the outer periphery into the second column installation port 30b, the second capillary column 6 and the connector main body 30 are connected such that the sample gas does not leak by screwing the pressing member 35 into the inner peripheral surface of the nut 32b and compressing the ferrule 31. At this time, the tip of the second capillary column 6, which is arranged in the interior space 30c, is inserted into the other end of the tube 36.

Later, if the inner peripheral surface of the tube 36 becomes contaminated from use of the metal union C1, first, the second capillary column 6 with the ferrule 31 mounted on the outer periphery is removed by removing the pressing member 35 from the interior of the nut 32b, and the first capillary column 5 with the ferrule 31 mounted on the outer periphery is removed by removing the nut 32a. Next, the nut 32b, lid member 34, and tube 36 are removed in that order. Then, the contaminated tube 36 is replaced with a new tube 36 part.

As described above, according to the metal union C1 of the present invention, it is not necessary to conduct deactivation processing treatment in the inner peripheral surface of the connector main body 30, and costs can be confined because the inner peripheral surface of the connector main body 30 does not become contaminated and require replacement with a new connector main body 30 part.

The present invention can be used in gas chromatography and the like that can separate just low boiling point hydrocarbons from sample gas in which low boiling point hydrocarbons and high boiling point hydrocarbons are mixed.

1. A capillary column connector comprising:
a metal connector main body comprising:
a first column installation port into which a first capillary column is inserted, a second column installation port into which a second capillary column is inserted,
an internal space, in which are arranged the tip of the first capillary column that has been inserted from said first capillary installation port and the tip of the second capillary column that has been inserted from said second capillary installation port, and
a gas supply route that is connected to said interior space, and
a metal tubular member movable in and out of the aforementioned internal space, and
wherein with the tip of the first capillary column inserted from one end of said tubular member and the tip of the second capillary column inserted from the other end of said tubular member, the tubular member is arranged in said internal space, and the gap between the internal peripheral surface of one end of said tubular member and the outer peripheral surface of the first capillary column as well as the gap between the internal peripheral surface of the other end of said tubular member and the outer peripheral surface of the second capillary column are purged with gas from said gas supply flow path.

2. The capillary column connector according to claim 1, wherein the internal surface of said tubular member is inert in relation to the sample gas that flows in said first capillary column and second capillary column.

3. The capillary column connector according to claim 1, wherein ferrule mating spaces are formed in said first column installation port and second column installation port, and
compressible ferrules that perform the role of seals are mounted on the external periphery of said first capillary column and second capillary column, which are then inserted in said first column installation port and second column installation port.

4. The capillary column connector according to claim 3, further comprising a lid forming a mating space for the ferrule of said second column installation port,
said lid member is installed on said connector main body, and can be removed from said connector main body, and
said tubular member can be moved in and out of said internal space by removing said lid member from the connector main body, and the tubular member is secured in said internal space by assembling said lid member on the connector main body.
